(19) United States
(12) Patent Application Publication
(10) Pub. No.: US 2005/0278540 A1
(43) Pub. Date: Dec. 15, 2005

(54) System, method, and computer program product for validating an identity claimed by a subject

(75) Inventors: Wongyu Ted Cho, San Jose, CA (US); Doyon Kim, San Jose, CA (US); Jinkeun Paul Choi, San Jose, CA (US)

Correspondence Address: SQUIRE, SANDERS & DEMPSEY L.L.P, 600 HANSEN WAY, PALO ALTO, CA, 94304-1043, US

(73) Assignee: OPINITY, INC., San Jose, CA (US)

(21) Appl. No.: 10/908,756

(22) Filed: May 25, 2005

Related U.S. Application Data
(60) Provisional application No. 60/574,989, filed on May 26, 2004.
(60) Provisional application No. 60/669,702, filed on Apr. 8, 2005.

(51) Int. Cl. H04K 1/00

(52) U.S. Cl. 713/182

(57) ABSTRACT

Embodiments of a system, method, and computer program product for validating an identity claimed by a subject are described. Information for logging in under an identity claimed by a subject is obtained from the subject and then submitted in an attempt to login under the claimed identity. The response to the login attempt is then analyzed to determine whether the identity with the site claimed by the subject is valid.

### CROSS REFERENCES TO RELATED APPLICATIONS

This application claims the benefit of U.S. Provisional Application No. 60/574,989, filed May 26, 2004, and U.S. Provisional Application No. 60/669,702, filed Apr. 8, 2005, both of these applications being incorporated by reference herein in their entirety.

### TECHNICAL FIELD

Embodiments described herein may relate generally to identity verification and consolidation.

### BACKGROUND

Users interact with other users on the Internet everyday. For example, users regularly buy, sell and trade goods, communicate, exchange information, play games with other users over the Internet. Traditionally, human interaction involved some sort of physical contact, whether it be direct (e.g. face to face) or indirect (e.g. via the phone). On the other hand, interaction over can be conducted without such intimate contact and with a degree of anonymity.

However, many people have conducted scams or other frauds by taking advantage of the anonymity on the web. As a result, taking cautionary measures before conducting an Internet interaction has become more and more important. There are many ways to minimize the risk of interaction: references can be collected and credit reports can be obtained before an important transaction is made. However, over the Internet, anonymity is often quite cherished.

Because of this anonymity, the security of transactions or any advice conducted over the Internet may be more unreliable. To help increase the reliability of Internet transactions, service providers have developed user rating processes for building site-specific user reputations for users participating in the offered services. For example, eBay, Inc., an on-line auction service, maintains a user reputation database that allows a user to check the reputation of a potential buyer or seller. Users add to their reputation, for example, by participating in auctions, either as a buyer or seller. However, a problem with such services is that a user generally cannot transfer his or her reputation outside of the service providing the reputation system.

### SUMMARY

Embodiments of a system, method and computer program product for validating an identity claimed by a subject are described. In general, login information may be obtained for logging in to a computer system (e.g., a computer, a website) under an identity claimed by a subject. The obtained login information may then be submitted to the computer system in an attempt to login (i.e., a login attempt) under the claimed identity. A response from the computer system to the login attempt may be received, for example, via the network and may include content presented by the computer system in response to the login attempt. The response by the computer system (i.e., the content presented by the computer system) may then be analyzed in response to the login attempt to determine whether the identity with the site claimed by the subject is valid (i.e., to confirm whether or not the identity claimed by the subject is in fact associated with the site).

In one embodiment, the login information may include a password that the subject claims is associated with the identity. The login information may further include an identifier such as a user ID associated with the claimed identity.

In one implementation, the login information can be obtained from the subject during registration (i.e., a registration process) by the subject with a service such as, for example, a reputation consolidation service, so that the identity is included in an account of the subjection maintained by the service. In such an implementation, the login information may obtained from the subject in response to a request to the subject during the registration process.

In one embodiment, the received login information may also identify a computer system to which the login information is to be submitted. In such an embodiment, a determination may also be made as to whether the computer system is pre-registered with a service, for example) and, if the computer system is determined not to be pre-registered, the computer system can be registered with the service prior to the submitting of the login information.

In one implementation, the registering of the site may include accessing the computer system (e.g., via the network) to analyze pages of the computer system in order to locate a login page of the computer system that is capable of receiving login information and then storing location-related information (e.g. a network address, a URL, a file name) for use in subsequent attempts to locate/access the login page. The analysis of the pages of the computer system may further include iteratively searching the pages of the computer system for computer code that defines an input field adapted for receiving (i.e., accepting input) login related information.

In one embodiment, the iterative search can include, for each page, searching the page for the computer code defining the input field and, if the computer code defining the input field is not found in the page, searching the page for links to other pages of the computer system. The input field may comprise a password input field adapted for receiving a password. The input field may also be defined by a tag (e.g., an HTML tag such as password tag) so that search for the input field comprises a search for such a tag. The searching of the page for links to other pages can be carried out by conducting a keyword search of the page for links to other pages of the computer system that contain login-related keywords such as, for example, password-related keywords.

In one implementation, the registering of a computer system may further include accessing a login page of the computer system and then submitting, in a login attempt, random characters in an input field presented in the login page. The submission of random characters should result in the presentment of a failure to login page generated by the computer system. The presented failure to login page can then be analyzed for failure-related keywords. Failure-related keywords that are found in the analysis of failure to login page along with the address (e.g., URL) of the failure to login page can be subsequently be stored in an entry associated with the computer system.

In one embodiment, the submission of the login information in the login attempt may also include obtaining location information for locating to a login page of the computer system adapted for receiving the obtained information (e.g., a network address or URL of the login page). The location information can be obtained, for example, from a database containing entries for registered computer systems. The login page may then be accessed using the location information so that the login information can be input into at least one input field in the login page to submit the login information to the associated computer system.

In one embodiment, the analysis of the response to the login attempt may comprise comparing the response to the login attempt to a previously obtained failure to login response (i.e., a failure to login page). This failure to login response may be obtained from the associated computer system in response to input submitted to the computer system that was expected to cause a failure to login condition. The analysis of the response to the login attempt may also comprise searching the response for success-related keywords indicating that a successful login attempt (i.e., login to the computer system was successful using the obtained login information).

In one embodiment, the claimed identity can be as a valid identity of the subject if a predetermined number of or particular success-related keywords are found in the analysis of the response. The claimed identity can be rejected as being a valid identity of the subject (i.e., an invalid identity) if the response matches the failure to login response/page and/or a predetermined number of or particular success-related keywords are not found in the analysis of the response.

### BRIEF DESCRIPTION OF THE DRAWINGS

FIG. 1 is a flowchart of a process for confirming whether an identity claimed by a subject is actually registered with a site identified by the subject in accordance with one embodiment;

FIG. 2 is a flowchart of a process for determining whether a site has a login format that is compatible with an intended use in accordance with one embodiment;

FIG. 3 is a flowchart of a process for analyzing a page of a site for determining whether the site has a login page/system that is compatible for an intended use in accordance with one embodiment;

FIG. 4 is a flowchart of a process for capturing information about login failure results from a failure to login page of a site in accordance with one embodiment;

FIG. 5 is a flowchart of a process for rating a subject such as, for example, a person, an identity of a person, an entity and/or a business utilizing, for example, a reputation consolidating system in accordance with one embodiment;

FIG. 6 is a flowchart of a process for accessing a reputation report of a subject from a reputation consolidation system for example in accordance with one embodiment;

FIG. 7 is a schematic diagram of an exemplary reputation report that may be generated by a reputation consolidation system in accordance with one embodiment;

FIG. 8 is a schematic block diagram of an exemplary system architecture that may be utilized for implementing embodiments described herein;

FIG. 9 is a schematic block diagram of an illustrative architecture that may be utilized for implementing for a reputation consolidator in accordance with an exemplary embodiment;

FIG. 10 is a schematic diagram of an illustrative network system in accordance with an exemplary embodiment; and

FIG. 11 is a schematic diagram of a representative hardware environment in accordance with one embodiment.

### DETAILED DESCRIPTION

In general, embodiments of a system, method, and computer program product for validating an identity claimed by a subject are described herein where information for logging in under an identity claimed by a subject is obtained from the subject and then submitted in an attempt to login under the claimed identity. The response to the login attempt is then analyzed to determine whether the identity with the site claimed by the subject is valid. This specification incorporates by reference U.S. Provisional Application No. 60/60/574,989, filed May 26, 2004, and U.S. Provisional Application No. 60/669,702, filed Apr. 8, 2005, in their entirety.

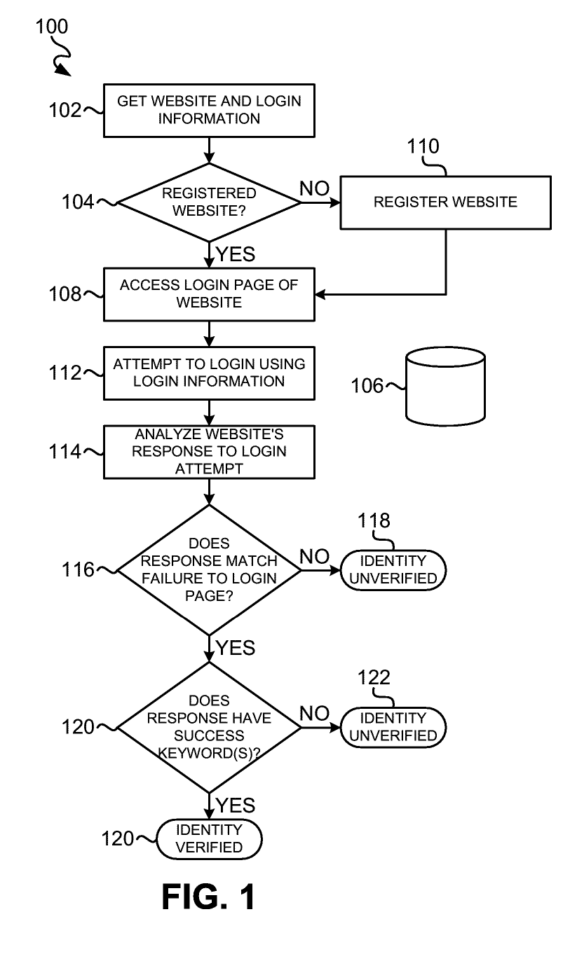

FIG. 1 shows a flowchart of a process 100 for confirming whether an identity claimed by a subject is actually registered with a site identified by the subject. Using embodiments of this process can provide a way of verifying, for example, a subject's claim of having an account with a given entity for instance a seller's account with the online auction website Ebay (www.ebay.com). In other words, embodiments of this process may be used to verify whether a subject is a registered user of a given site or service. While the embodiments described herein are described in the context where the site comprises a website, it should be understood that embodiments could also be implemented where the site comprises one or more files stored in a memory device such as, for example, a hard disk drive.

In operation 102, identity information is obtained about an identity at a site with which a subject claims to be associated. The identity information may be obtained directly from the subject, for example, in response to a query for this information. For instance, the subject may be presented (e.g., via a network) with a form that has input fields into which the subject can input the identity information (and thereby submit the identity information).

The identity information may include information for logging in to a site as the claimed identity (also referred to as login information) such as, for example: a user or account name (also known as a user ID) associated with the claimed identity; and/or a password or other authorization code associated with the claimed identity that can be used to access features, services and/or restricted information associated with the claimed identity. The identity information may also include information about the site that can be used to locate and access the site via a network such as, for example, the name of the site (also referred to as the site name or sitename) and/or an address of the site such as a Uniform Resource Locator (URL) of the site. In an embodiment, where the site comprises a file, the identity information may include file path information (also known as a file name) that is indicative about the location of the file in the memory device and that can be used to locate the file in the memory device.

In decision 104, a determination is made whether the site is a site that has been pre-registered, in other words, whether the site has been analyzed and found to have a compatible login format. This determination may be performed by searching a database 106 of registered sites using at least a portion of the site information included in the obtained identity information. In one embodiment the database of registered sites may comprise a table of registered sites (also referred to as a Sites table) that includes entries for each registered site containing information about the respective site such as, for example: information about a title page of the site, a description of the site, a domain (e.g., URL or domain name of the site), information about a login page of the site. A login page may be defined as the page of the site at which attempts to login to the site may be performed. A login screen and/or a login window or frame that is used to login into a site may also be considered a login page. The information about the login page of the site may include the URL or the login page, and information about what is generated and/or presented by the site up on a failure to login event. A failure to login event may be defined as an event that occurs when an attempt to login in to a site (or file) using a password or other login information fails and access to of the site (or restricted portions, or features/services thereof) is denied.

If the site is determined to be a pre-registered site, then the YES path from decision 104 is followed to operation 108. In operation 108, an attempt is made to access the login page of the site using, for example, information about the login page of the site obtained from the database 106 (e.g., from the Site table in the database). If the site is determined to not be a pre-registered site, then the NO path from decision 104 is followed to operation 110 where the site may be analyzed and registered in the database. After (and if) the unregistered site is registered, then operation 108 may be performed for the newly registered site.

After the login page of the site is accessed, an attempt may be made, in operation 112, to login to the site using at least a portion of the identity information obtained from the subject. The input identity information submitted to the site may then be used by the site's login process to determine whether to permit the logging in to the site (e.g., whether to grant access to the restricted portion(s) of the site). In one implementation, the login attempt may comprise an attempt to establish an Hyper Text Transfer Protocol (HTTP) session with the site and, in such an implementation, the response from the site to the login attempt may indicate whether or not the HTTP session was successfully established.

The identity information used in the login attempt in operation 112 may comprise at least a portion of the login information obtained from the subject. The login attempt may be performed in operation 112 by inputting at least a portion of the login information obtained from the subject into corresponding input fields of the accessed login page (and thereby submitting the login information to the site). In an exemplary embodiment where the identity information provided by the subject includes a user ID and password, the user ID and password may be input into corresponding input fields (i.e., a user ID input field and a password input field) presented on the login page of the site to submit the inputted user ID and password to the site. In one embodiment, at least the password provided by the subject is submitted to the site via the login page.

The response to the login attempt by the site is obtained and analyzed in operation 114 to determine whether the login attempt was successful. The analysis in operation 114 may be performed by comparing the site's response to information about known responses by the site. The information about known responses by the site may be stored in and retrieved from the database (e.g., in the Sites table). The information about known responses may include, for example, information about one or more known failure to login pages (or frames or windows) of the site that are generated/presented by the site in response to an unsuccessful login attempt and that include information or indicia that indicate that the attempt to login to the site was unsuccessful. The information about known responses may also include, for example, information about one or more known login success pages (or frames or windows) of the site that are generated/presented by the site in response to a successful login attempt and that include information or indicia that indicate that the attempt to login to the site was successful.

In the implementation shown in FIG. 1, the analysis may first compare the site's response to the login attempt using the identity information provided by the subject with a failure to login page known to be generated by site that is stored and retrieved from the database (see decision 116). If the site's response matches the known failure to login page, then the MATCH path from decision 116 is taken and the subject's claim to the identity is rejected (see block 118). In such an instance, the subject's claimed identity may be designated as “unverified” to indicate that the subject's claim to the identity could not be verified by logging into the site. The unverified designation may be stored in a database in an entry associated with the subject. In one implementation, this entry about the subject may be maintained in an Identity table in the database.

On the other hand, if the comparison of the site's response to the login attempt does not match the known failure to login page of the site, then the NO MATCH path may be followed from decision 116. In such case, the site's response may be further analyzed by searching the response for keywords that indicate that the login attempt was successful (i.e., a success-related keyword search) in decision (see decision 120). As an option, a keyword search can also be made for keywords that suggest that the login attempt was unsuccessful (i.e., failure-related keyword search) in addition to the success-related keyword search. Exemplary success-related keywords can include, for instance: “login successful,” “welcome,” “hello,” “my profile,” words (e.g., alpha-numeric characters) included in the identity information provided by the subject (e.g., user ID). The success-related keywords can also include words and indicia relating to a log-off because finding words such as “log-off,” “exit,” “sign off,” “sign out” on a page may also indicate that login was successful.

If the success-related keyword search of the site's response does not find any or a sufficient number of success-related keywords (e.g., a predetermined number of success-related keywords or the finding of one or more specific success-related keywords in the site's response) and/or if a sufficient number of failure-related keywords are found in the failure-related keyword search of the site's response (e.g., a predetermined number of failure-related keywords or the finding of one or more specific failure-related keywords are found in the site's response), then the NO path from decision 120 may be followed and the subject's claim to the identity at the site is rejected (see block 122). Similar an event leading to block 118, the subject's claimed identity may be designated in block 122 as “unverified” to indicate that the subject's claim to the identity could not be verified by finding of a sufficient number of success-related keywords (or failure-related keywords). This unverified designation may also be stored in a database in an entry associated with the subject (e.g., in the Identity table).

Conversely, if a sufficient number of success-related keywords or one or more particular keywords are found in the keyword search of the site's response, then the YES path from decision 120 may be followed and the identity with the site claimed the by the subject can be accepted (i.e., verified/confirmed) as indicated by block 124. In such an instance, the subject's claimed identity may be designated as “verified” or “confirmed” to indicate that the subject's claim to the identity was verified by the process 100. The verified designation may be stored in a database in an entry associated with the subject that, as previously described, may be maintained in an Identity table in the database for example.

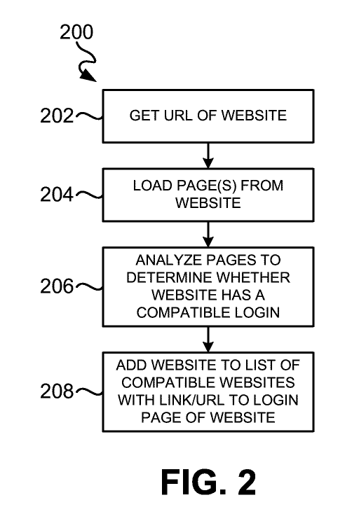

FIG. 2 shows a flowchart of a process 200 for determining whether a site has a login format that is compatible with an intended use. Embodiments of this process 200 may be implemented, for example, to pre-register a site before identity information is obtained from a subject (see operation 102 shown in FIG. 1) and/or to register a site that has not yet been registered (see operation 110 shown in FIG. 1).

In the process 200 shown in FIG. 2, an address (e.g., a URL) of a site to be analyzed to determine its compatibility is obtained in operation 202. The address may be used to access the site and download one or more pages of the site in operation 204. In operation 206, the downloaded page(s) are analyzed to determine whether the site has a login page (or login screen/window) and, if so, whether the format of the site's login page is suitable for an intended use (i.e., whether the site's login page/system is compatible with the intended use).

As previously described, a login page may be defined as the page of a site at which attempts to login to the site may be performed. A login page may include one or more input fields into which login information may be input and submitted to the site so that the site can determine whether to grant access by accepting the login attempt. The one or more input fields of a login page may include, for example, an input field for receiving a user/account name or a user/account ID (i.e., a user ID input field), an input field for receiving a password (i.e., a password input field).

In one implementation, a compatible login page may include at least a password input field into which a password (e.g., a textual password) may be input and submitted to the site to gain login access to the site. An exemplary intended use may comprise a process for verifying an identity (e.g., process 100 of FIG. 1).

Such an implementation may be utilized by a reputation consolidation system to identify, in sites having reputation related information, login pages that may be compatible for use with the reputation consolidation system (i.e., an intended use of the implementation).

If the analysis of the site in operation 206 indicates that the site's login page is compatible with the reputation consolidation system, then the site may be added to a list of sites having compatible login systems in operation 208. The site's entry in the list may also include the address of (e.g., URL) and/or link to the site's login page. The list of compatible sites (and links to their login pages) may be stored in a database as entries, for example, in a Sites table maintained in the database.

If, on the other hand, the analysis of the site in operation 206 indicates that the site does not have a compatible login page/system, then a notice may be generated to notify the reputation consolidation system of the sites incompatibility. As a further, option, an entry for the site may be added to a list of sites that have incompatible login pages/systems for use with the reputation consolidation system (this list of incompatible sites may also be stored in a database maintained by the reputation consolidation system.

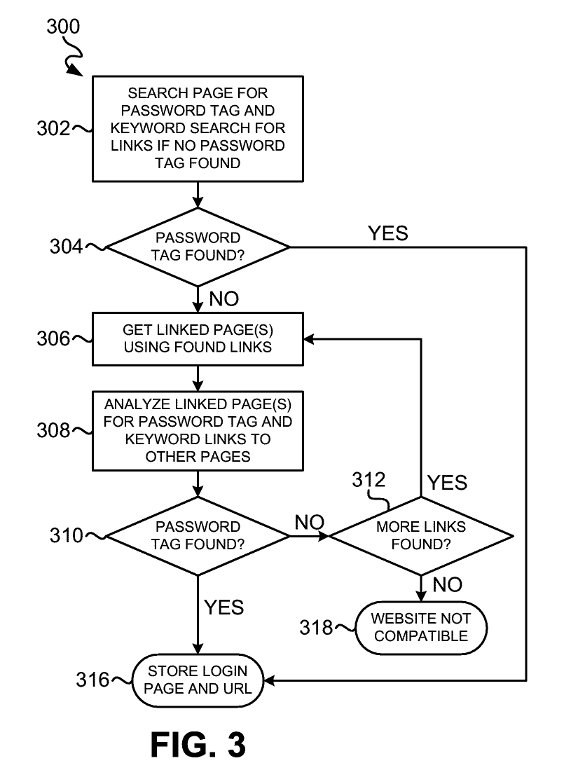

FIG. 3 shows a flowchart of a process 300 for analyzing a page of a site for determining whether the site has a login page/system that is compatible for an intended use. Embodiments of this process 300 may be implemented, for example, to analyze pages of a site to determine whether the site has a login page compatible for an intended use as set forth in operation 206 shown in FIG. 2. In one implementation, some sort of crawler or spider (e.g., a web crawler) may be utilized to carry out embodiments of the process 300 shown in FIG. 3. In such embodiments of the process 300, some sort of deep searching or deep crawling technique may be implemented to search/analyze the pages of a site for the password input field and/or for links to other pages in the site. With regards to an intended use, embodiments of the process 300 shown in FIG. 3 may be utilized by a reputation consolidation system to identify—in sites that may have reputation related information—login pages that may be compatible for use with the reputation consolidation system.

After a page of a site has been captured (e.g., see operation 202 of the process 200 in FIG. 2), the page may be analyzed (e.g., searched) to determine whether the page contains a password input field and, if no password input field is found, a keyword search of the page may be conducted for links with password related keywords to determine whether the page contains any links to other potential login pages of the site (see operation 302 and decision 304). In one embodiment, the page may be comprised of computer code, more particularly, computer code generated from a markup or extensible programming language such as, for example, HyperText Markup Language(HTML) or Extensible Markup Language (XML). In such an embodiment, the search of the page may comprise a search of the computer code that makes up the page. For example, the search of the computer code may include a search for tags including a password tag for creating a password input field and link tags for creating links to other pages of the site (and/or other sites).

Any links that are found are followed to access (e.g., load and capture) their linked pages in operation 306. The linked pages may then analyzed (e.g., searched) in operation 308 to determine whether any of them contain a password input field (e.g., a password tag) and, if a password input field is not found, the pages are subject to a keyword search using password related keywords to determined whether any of the pages contains password related links (i.e., the pages are searched for links with password related keywords). An iterative analysis/search of pages of the site for password tags and links with password related keyword is continued until either a page with a password tag is found or no more password related links are found (see NO path from decision 310 and YES path from decision 312).

If a password tag is found during the search (see YES paths from decisions 304 and 310), then the site is determined to have a compatible login page/format and an appropriate entry for the site/page may be stored in a database (see block 316). The database entry may indicate that the site's login page format is compatible and that contains the address (e.g., URL) of the page having the password tag. The database entry may also include additional information about the password input field including the a copy of the password tag used to generate the password input field.

If, on the other hand, the search for linked pages is exhausted and no password input field (i.e., no password tag is found) is after searching all of the linked pages, then the site is determined not have a compatible login page format (see block 318). As an option, an appropriate entry may be added to the database for such a site that indicates that the site does not have a compatible login page format.

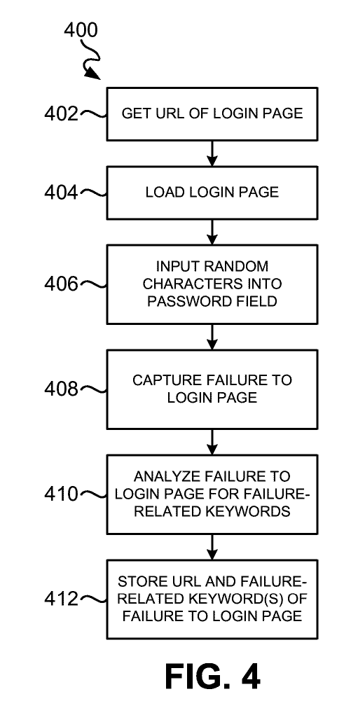

FIG. 4 shows a flowchart of a process 400 for capturing information about login failure results from a failure to login page of a site. Embodiments of the process shown in FIG. 4 may be carried out to assist implementation of operation 114 of the process 100 shown in FIG. 1.

In operation 402, information is obtained about an address (e.g., a URL) of a page of a site that has a password input field for the site. This page may be referred to as a login page of the site that is used for logging into the site. In one embodiment, the login page of the site may be defined (i.e., created or generated) from computer code that includes a password tag that defines the password input field. The computer code defining the login page may also include a user identifier tag used to generate a user ID input field.

In operation 404, the information obtained in operation 404 is used to access the page (and thereby its user ID and/or password input field) in operation 404.

In operation 406, randomly selected characters (e.g., gibberish) may be input into the user ID input field and/or password input field of the login page of the site and submitted to the site as a login attempt.

In response, the login system of the site should reject the input characters and present a page that includes some sort of information that indicates that there was a failure to login to the site (see operation 408). The presented information/page presented as result of the failure to login may be referred to as a failure to login page. In operation 408, the displayed failure to login page is captured for analysis.

In operation 410, the analysis of the failure to login in page may include searching for and obtaining the address (e.g., URL) of the failure to login page. The analysis may also include a keyword search of the failure to login page to locate failure-related keywords. Exemplary failure-related keywords can include, for instance: “login unsuccessful,” “login failed,” “sign in failed,” “failed,” “try again,” “incorrect,” and “unknown.”

In operation 412, the address (i.e., URL) of the failure to login page and any failure related keywords that were found in search of the failure to login page may then be stored in a database as an entry associated with the site and/or the failure to login page.

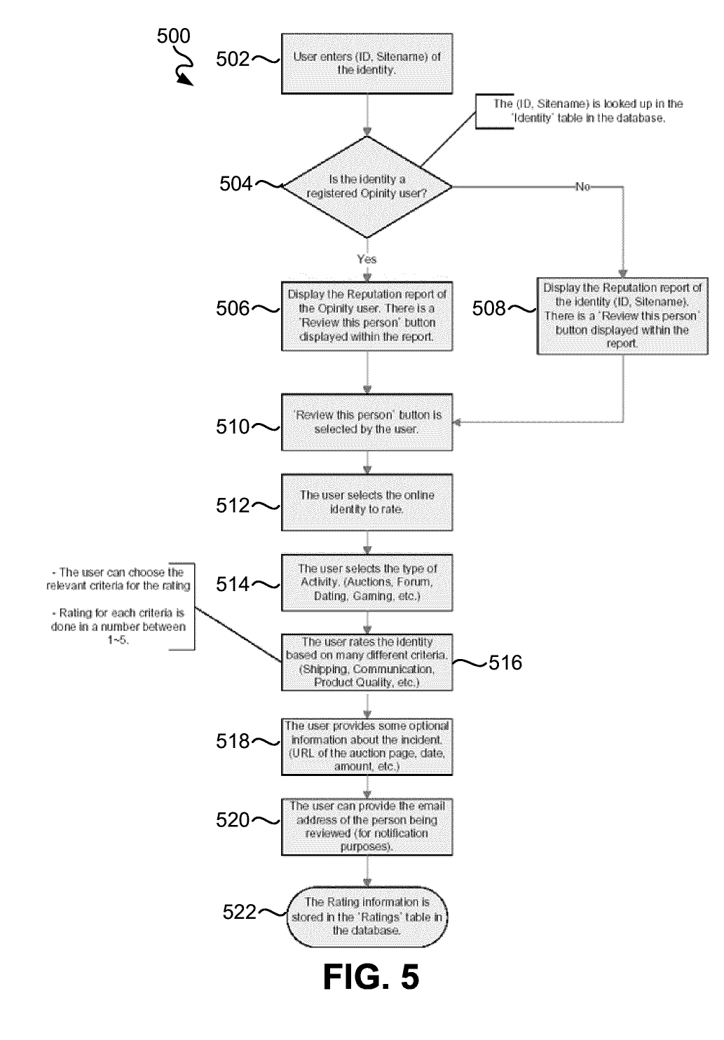

FIG. 5 shows a flowchart of a process 500 for rating a subject such as, for example, a person, an identity of a person, an entity and/or a business utilizing, for example, a reputation consolidating system. In operation 502, a reviewer is prompted to input information about an identity of a subject to be reviewed and a site name associated with the identity. The site name may comprise a commonly used name of the site and/or an address (e.g., URL) of the site. An example of a site name is www.ebay.com for the site of the company Ebay.com. In this Ebay.com example, the identity of the subject may be a name of a seller registered to sell items on the Ebay.com site (i.e., a registered seller's name).

The identity and site name input by the reviewer may then be analyzed to determine whether the input identity is that of a subject previously registered with a reputation consolidation system (see decision 504). The determination in decision 504 may be conducted by checking the identity and site name provided by the reviewer to a database of identifiers at given sites of users registered (i.e., registered users) with the reputation consolidation system. If the identity is associated with registered user of the reputation consolidation system, then a reputation report of the registered user may be retrieved and displayed to the reviewer in operation 506. On the other hand, if the identity is not associated with any registered user of the reputation consolidation system, then a determination can be made as to whether a reputation report has been previously created for the input identity and, if so, the presented to the reviewer. If the input identity does not have a previously created reputation report, then the reputation consolidation system may create a new reputation report for the identity and present this newly created reputation report to the reviewer in operation 508.

In operation 510, the reviewer may then be invited by the reputation consolidation system to provide a review about the identity (i.e., rate the identity) by, for example, displaying a selectable “review this person” button to the reviewer. If the reviewer decides to provide a review about the identity by, for example, selection of the review this person button (see operation 512), then the reputation consolidation system may present the reviewer with one or more activities for which the reviewer can select to provide a review of the identity. Some illustrative activities include, for example, auctions, forum, dating, and gaming. Once an activity is selected (see operation 514), the reviewer may rate the identity and thereby provide a review of the identity to the reputation consolidation system in operation 516. In order to facilitate the review, the reputation consolidation system may present various criteria for which the reviewer can provide his or her rating. Illustrative criteria include, for example, shipping, communication, and product quality. In one embodiment, the various criteria may be rated on a numerical scale such as, for example, a rating scale between 1 and 5.

In one embodiment, the reputation consolidation system may present the reviewer with additional input fields for receiving (see operation 518) additional information that the reviewer may wish to include in his or her review. For example, the reputation consolidation system may include a textual field in which the review may input text describing, for example, an event, incident, transaction, or encounter with the identity under review. This information may include, for example, an address (e.g., URL) of a site at which the event occurred, the date that the event occurred, and/or an amount of money involved in the event. The reputation consolidation system may also present the reviewer with an input field into which the reviewer may input the email address of the identity under review (see operation 520) so that this address may be used to send a notice to notify the identity under review about the review. The reputation consolidation system may store the review provided by the reviewer in a database in, for example, a ratings table in the database (see block 522).

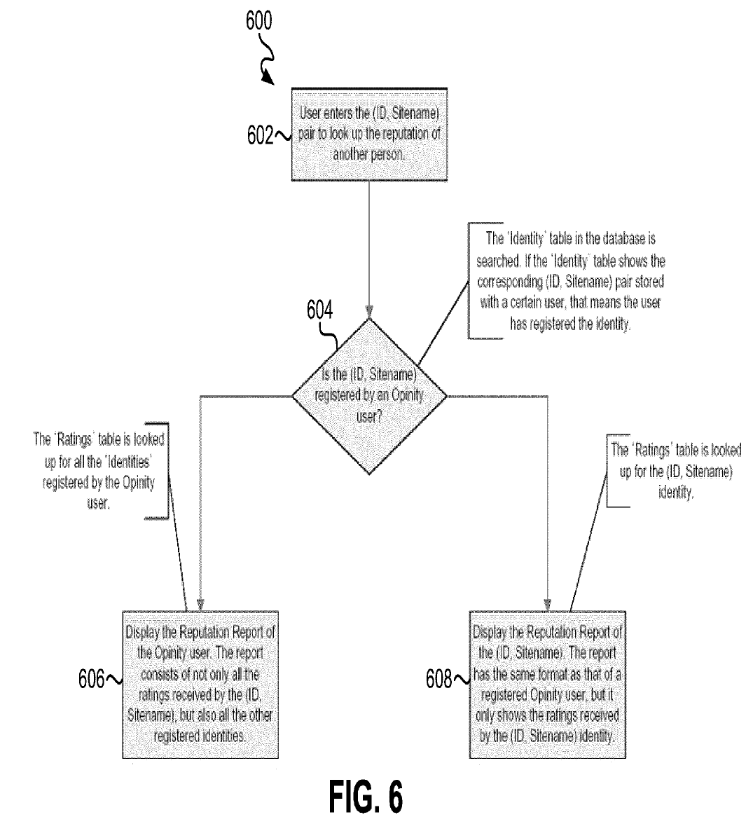

FIG. 6 shows a flowchart of a process 600 for accessing a reputation report of a subject from a reputation consolidation system for example. A user (i.e., an inquirer) seeking to access a reputation report of a subject from a reputation consolidation system may access a site provided by reputation consolidation system and provide the reputation consolidation system with an identifier and associated site name of the subject in operation 602. The provided identifier and associated site name may be used by the reputation consolidation system to search its database(s) to determine whether the identity is associated with a registered user of the reputation consolidation system (see decision 604).

If the identity is determined to be associated with a registered user of the reputation consolidation system, then a ratings table is searched for all identities that are associated with the registered user and a reputation report is displayed to the inquirer that contains ratings received for the input identity as well as all other known identities associated with the registered user in operation 606. If the identity is determined not to be associated with a registered user, then the ratings table is searched to obtain any reviews previously received from the provided identifier and a reputation report is presented to the inquirer that presents any previously received reviews for the provided identity (see operation 608).

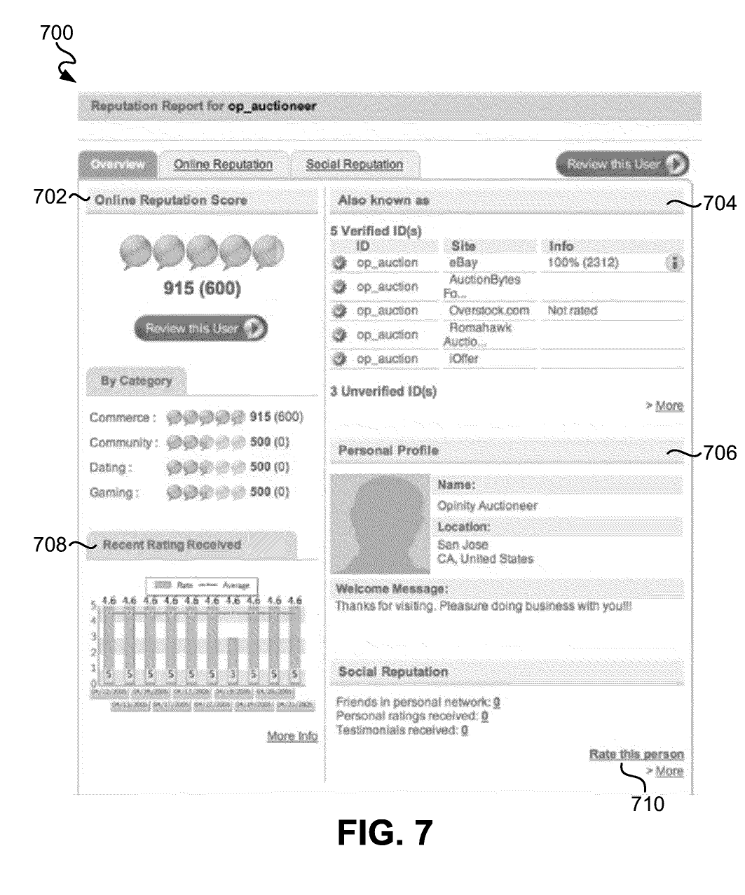

FIG. 7 is a schematic diagram of an exemplary reputation report 700 that may be generated by a reputation consolidation system. The exemplary reputation report 700 shown in FIG. 7 is generated using data about a registered user of the reputation consolidation system. The exemplary reputation report 700 may include a consolidated reputation score 702 for the user that may derived from one or more reputation sub-scores obtained from other sites as well as ratings provided to the reputation consolidation system by independent reviewers. The exemplary reputation 700 report may also include a listing 704 of verified identities at various other sites associated with the registered user as well as a profile 706 of the registered user that provides personal information about the user. In addition, the reputation report may include an area 708 for displaying recent ratings of the user made by one or more reviewers. The reputation report 700 may further include a user-selectable link 710 (e.g., a “Rate this person” link) that upon selection thereof, causes the reputation consolidation system to present a form for receiving a review of the registered user from a reviewer.

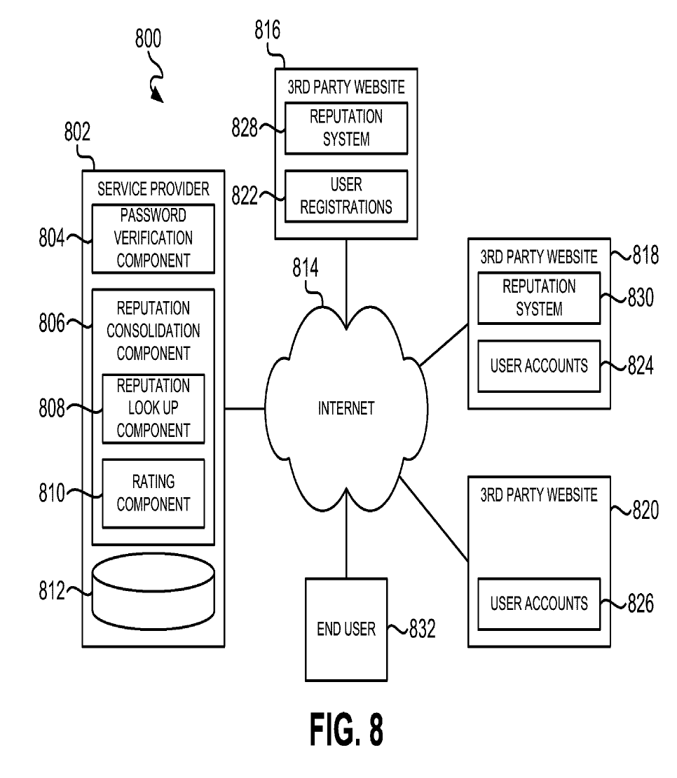

FIG. 8 is a schematic block diagram of an exemplary system architecture 800 that may be utilized for implementing embodiments described herein. The system 800 may include a service provider 802 capable of providing reputation consolidation services and, as such, may also be referred to as a reputation consolidator.

The reputation consolidator 802 may include a password verification component 804 for verifying user identifiers such as passwords, user names, and so on. The reputation consolidator 804 may also include a reputation consolidation component 806 for providing services for consolidating multiple reputations. The reputation consolidation component 806 may include a variety of sub-components including, for example, a reputation look up component 808 for permitting users to look up information related to a subject's reputation (i.e., reputation information) and a rating component 810 for permitting users to provide or add information about a subject's reputation such as, for instance, rating a subject and/or providing commentary on a subject. The reputation consolidator 802 may further include a data store 812 for storing data. The reputation consolidator 802 may be coupled to one or more networks 814 including wide area networks (e.g., the Internet) and/or local area networks to permit remote access of services, features and/or components of the reputation consolidator.

A plurality of third party sites 816, 818, 820 (e.g., third party websites) may also be coupled to the network(s) 814 to permit access to the third party sites via the network. As websites, the party sites may comprise a plurality of pages that can be utilized by the sites to present content and receive input and other data. The third party sites may have registered users and/or user accounts 822, 824, 826 that may be established to provide content, services and/or other features to such users. Some of the third party sites may also include reputation systems 828, 830 that, for example, may permit users to provide reputation information about other users of the particular third party site (e.g., rate the other users of a given site) and/or obtain reputation information about other users of the particular third party site (e.g., look up rating information about other users of a given site). Some illustrative reputation systems provided by third party sites include eBay Inc.'s feedback forum, Yahoo! Inc.'s merchant rating system and Amazon.com, Inc.'s feedback rating system.

One or more end users 832 may be coupled to the network 814 to permit the end user 832 to access and interact with the reputation consolidator 802 and/or the third party sites 816, 818, 820.

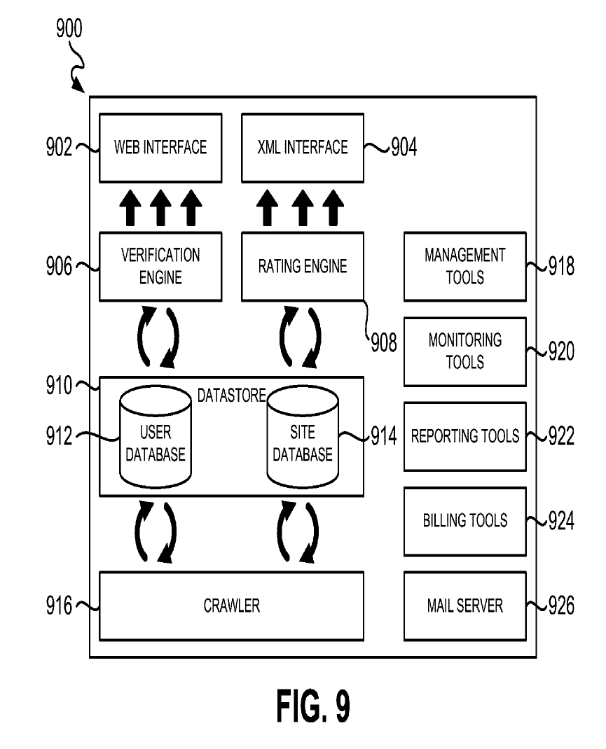

FIG. 9 is a schematic block diagram of an illustrative architecture for a reputation consolidator 900. The reputation consolidator 900 may have a plurality of interfaces including, for example, a web interface 902 and an XML interface 904. The interfaces 902, 904 may each be coupled to a network (e.g., the Internet) to provide an interface between the network and other components of the reputation consolidator 900. A verification engine 906 may be included in the reputation consolidator 900 for verifying user identifiers such as passwords and user names. The reputation consolidator 900 may also include rating engine 908 for handling reputation consolidation features.

A data store 910 of the reputation consolidator 900 may comprise a plurality of databases including a user database 912 for storing data about users and a site database 914 for storing data about third party sites. Some exemplary data that can be stored in the user database 912 may include data relating to identifiers, names, passwords and email accounts associated with a given user. The user database 912 may also store date and verification information about the user collected by the reputation consolidator. The site database 914 may be used to store data about the name and URL of a site as well as any information that may be used to categorize the site. The site database may also include data used to verify the site as well as content, elements and/or features of the site.

The data store 910 may include additional databases as well. For example, the data store may include an identities database for storing identity and verification information about users and third party sites, a ratings database for storing rating and other reputation related information about users, an objections database for storing complaints (e.g., complaints against ratings or comments made about a user), a user-identity database for storing user identity and verification data, and a site automation database for storing information about third party sites, automation identifiers associated with a third party site, and script/method data used by third party sites.

The reputation consolidator may further have a web crawler 916 (or similar collection component) for collecting information from third party sites via the network and a management tools 918 for facilitating management of components and functionality of the reputation consolidator 900. The management tools 918 may include monitoring tools 920 for permitting a user (e.g., an administrator) to monitor the components and functionality of the reputation consolidator 900, reporting tools 922 to permit the generating and creation of reports, statistics and information about components and functionality of the reputation consolidator 900, billing tools 924 for generating bills and managing billing issues for the reputation consolidator 900, and a mail server 926 for managing email related features of the reputation consolidator 900.

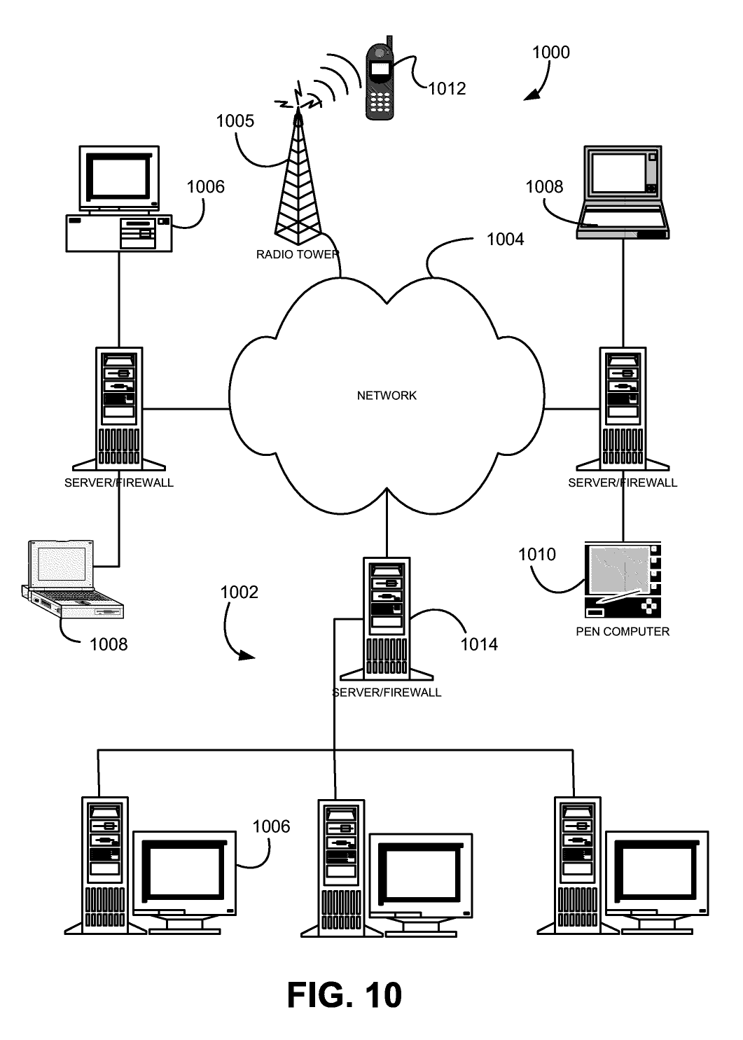

FIG. 10 illustrates an exemplary network system 1000 with a plurality of components 1002 in accordance with one embodiment. As shown, such components include a network 1004 which take any form including, but not limited to a local area network, a wide area network such as the Internet, and a wireless network 1005. Coupled to the network 1004 is a plurality of computers which may take the form of desktop computers 1006, lap-top computers 1008, hand-held computers 1010 (including wireless devices 1012 such as wireless PDA's or mobile phones), or any other type of computing hardware/software. As an option, the various computers may be connected to the network 1004 by way of a server 1014 which may be equipped with a firewall for security purposes. It should be noted that any other type of hardware or software may be included in the system and be considered a component thereof.

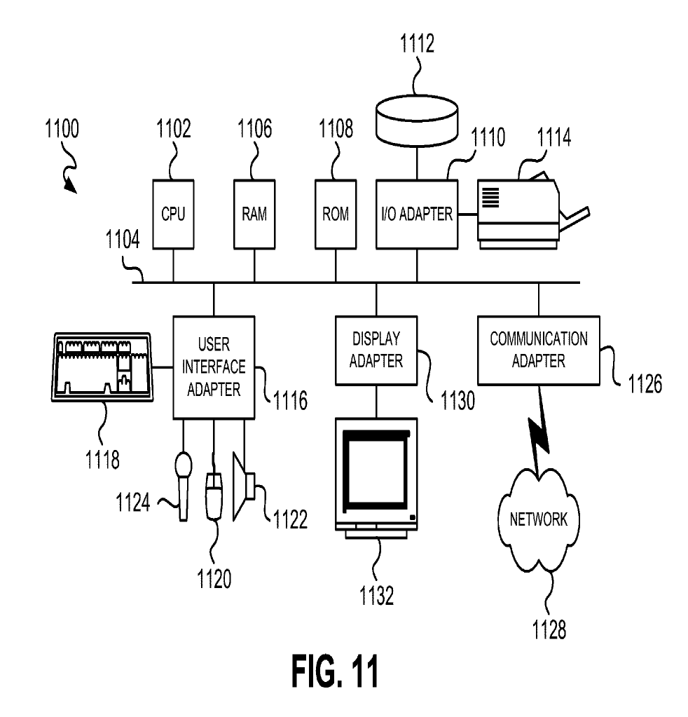

A representative hardware environment associated with the various components of FIG. 10 is depicted in FIG. 11. In the present description, the various sub-components of each of the components may also be considered components of the system. For example, particular software modules executed on any component of the system may also be considered components of the system. In particular, FIG. 11 illustrates an exemplary hardware configuration of a computer 1100 having a central processing unit 1102, such as a microprocessor, and a number of other units interconnected via a system bus 1104. The computer 1100 shown in FIG. 11 includes a Random Access Memory (RAM) 1106, Read Only Memory (ROM) 1108, an I/O adapter 1110 for connecting peripheral devices such as, for example, disk storage units 1112 and printers 1114 to the bus 1104, a user interface adapter 1116 for connecting various user interface devices such as, for example, a keyboard 1118, a mouse 1120, a speaker 1122, a microphone 1124, and/or other user interface devices such as a touch screen or a digital camera to the bus 1104, a communication adapter 1126 for connecting the computer 1100 to a communication network 1128 (e.g., a data processing network) and a display adapter 1130 for connecting the bus 1104 to a display device 1132. The computer may utilize an operating system such as, for example, a Microsoft Windows operating system (O/S), a Macintosh O/S, a Linux O/S and/or a UNIX O/S. Those of ordinary skill in the art will appreciate that embodiments may also be implemented on platforms and operating systems other than those mentioned. One of ordinary skilled in the art will also be able to combine software with appropriate general purpose or special purpose computer hardware to create a computer system or computer sub-system for implementing various embodiments described herein. It should be understood the use of the term logic may be defined as hardware and/or software components capable of performing/executing sequence(s) of functions. Thus, logic may comprise computer hardware, circuitry (or circuit elements) and/or software or any combination thereof.

Embodiments of the present invention may also be implemented using computer program languages such as, for example, ActiveX , Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided. OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:
Objects can represent physical objects, such as automobiles in a traffic-flow simulation, electrical components in a circuit-design program, countries in an economics model, or aircraft in an air-traffic-control system.
Objects can represent elements of the computer-user environment such as windows, menus or graphics objects.
An object can represent an inventory, such as a personnel file or a table of the latitudes and longitudes of cities.
An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

Some benefits of object classes can be summarized, as follows:
Objects and their corresponding classes break down complex programming problems into many smaller, simpler problems.
Encapsulation enforces data abstraction through the organization of data into small, independent objects that can communicate with each other. Encapsulation protects the data in an object from accidental damage, but allows other objects to interact with that data by calling the object's member functions and structures.
Subclassing and inheritance make it possible to extend and modify objects through deriving new kinds of objects from the standard classes available in the system. Thus, new capabilities are created without having to start from scratch.
Polymorphism and multiple inheritance make it possible for different programmers to mix and match characteristics of many different classes and create specialized objects that can still work with related objects in predictable ways.
Class hierarchies and containment hierarchies provide a flexible mechanism for modeling real-world objects and the relationships among them.
Libraries of reusable classes are useful in many situations, but they also have some limitations. For example:
Complexity. In a complex system, the class hierarchies for related classes can become extremely confusing, with many dozens or even hundreds of classes.
Flow of control. A program written with the aid of class libraries is still responsible for the flow of control (i.e., it must control the interactions among all the objects created from a particular library). The programmer has to decide which functions to call at what times for which kinds of objects.
Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:
Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.
Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.
Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Sun Microsystems defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNIX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requester. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet. OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object. An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Serialization involves saving the current state of an object to a stream, and restoring an equivalent object from that stream. The stream functions as a container for the object. Its contents include a partial representation of the object's internal structure, including variable types, names, and values. The container may be transient (RAM-based) or persistent (disk-based). A transient container may be used to prepare an object for transmission from one computer to another. A persistent container, such as a file on disk, allows storage of the object after the current session is finished. In both cases the information stored in the container can later be used to construct an equivalent object containing the same data as the original. The example code in this article will focus on persistence.

Inheritance may be defined as a relationship that defines one entity in terms of another. Class inheritance defines a new class in terms of one or more parent classes. The new class may inherit its interface and implementation from its parent class(es). The new class is called a subclass or a derived class. Class inheritance may combine interface inheritance and implementation inheritance. Interface inheritance defines a new interface in terms of one or more existing interfaces while implementation inheritance defines a new implementation in terms of one or more existing implementations. In object-oriented programming, inheritance may further be defined as an ability to create new classes (or interfaces) that contain all the methods and properties of another class (or interface), plus additional methods and properties. For example, if class (or interface) “B” inherits from class (or interface) “A”, then class B is said to be derived from class A. Class B may be referred to as a base (or super) class (or interface) for class D. When a class of objects is defined, any subclass that is defined may inherit the definition of one or more general classes. In the case where some modification to the definition is needed in the subclass, new methods and/or properties may be included in the definition.

A bit stream may be defined as a continuous transfer of bits over some medium. For example, a bit stream may comprise a series of transmitted bits through a transmission link.

A superclass (as referred to as a base or parent class) is one from which other classes are derived using inheritance. In class inheritance, the subclass is said to inherit its interface and implementation from its superclass(es). In object orientated programming, a superclass may be a class that is above another class in the class hierarchy. For example, class “A” may be a superclass of class “B” if classes A and B are on the same branch of a class hierarchy tree and class A is higher on that branch than class B.

In general, introspection may comprise the ability of an object to reveal information about itself as an object such as for example, the object's class, superclass), the messages the object is capable of responding to, and the protocols to which the object conforms. In Java, introspection may further comprise a process by which a class is read in order to create a representation of the object's application program interface (API). Introspection may be carried out by the Java Introspector class, which is part of the Java Core Reflection API. Introspection may be used to provide additional information about an object, supplementing information learned by reflection.

Run-time may be defined as a time during which a program is active and being executed or executing (i.e., the time the program is being run).

Design time may be defined as a time during which an application is being built in a development environment/process. Code may be created and edited during design time.

Transmission Control Protocol/Internet Protocol (TCP/IP) is a basic communication language or protocol of the Internet. It can also be used as a communications protocol in the private networks called intranet and in extranet. TCP/IP is a two-layering program. The higher layer, Transmission Control Protocol or TCP, manages the assembling of a message or file into smaller packet that are transmitted over the Internet and received by a TCP layer that reassembles the packets into the original message. The lower layer, Internet Protocol or IP, handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.). Several higher layer application protocols use TCP/IP to get to the Internet. These include the World Wide Web's Hypertext Transfer Protocol (HTTP), the File Transfer Protocol (FTP), Telnet, and the Simple Mail Transfer Protocol (SMTP). These and other protocols are often packaged together with TCP/IP as a “suite.” Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does). Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

Wireless may refer to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Encryption is the conversion of data into a form, called a ciphertext, that cannot be easily understood by unauthorized people. Decryption is the process of converting encrypted data back into its original form, so it can be understood. Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is often included as part of a web browser. The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet. The private key is used to decrypt text that has been encrypted with the public key. Thus, if a first party sends a message to a second party, the recipient second party may be able to find out the first party's public key (but not the first party's private key) from a central administrator and encrypt a reply message back to the first party using the first party's own public key. When the first party receives the reply message, the reply message may be decrypted by the first party with the first party's private key. In addition to encrypting messages (which ensures privacy), a first party may be able authenticate themselves to second party so that the second party can confirm the identity of the first party (and thus know that it is really the first party who sent the message) by using a private key to encrypt a digital certificate. When the second party receives the encrypted digital certificate, the second party may use the first party's public key to decrypt it.

A browser is an application program that provides a way to look at and interact with all the information on the World Wide Web. The word “browser” seems to have originated prior to the Web as a generic term for user interfaces that let you browse (navigate through and read) text files online. A Web browser may be considered a client program that uses the Hypertext Transfer Protocol (HTTP) to make requests of Web servers throughout the Internet on behalf of the browser user. While some browsers also support e-mail (indirectly through e-mail Web sites) and the File Transfer Protocol (FTP), a Web browser may not be required for those Internet protocols and more specialized client programs are more popular.

Hyper Text Transport Protocol (HTTP) is the communication protocol used to connect to servers on the World Wide Web and provides a set of rules for exchanging files (e.g., text, graphic images, sound, video, and other multimedia files). HTTP defines how messages are formatted and transmitted, and what actions Web servers and browsers should take in response to various commands.

HyperText Markup Language (HTML) is a programming language used for creating hypertext documents such as Web pages. HTML may be used to specifies how text will be formatted and displayed in a web browser. HTML is a collection of platform-independent styles (indicated by markup tags) that define the various components of a HTML document. HTML includes a set of markup symbols or codes that may be inserted in a file intended for display on page. Each individual markup code may be referred to as an element or a tag

XML (Extensible Markup Language) is a standard for creating markup languages which describe the structure of data. It is not a fixed set of elements like HTML, but rather, it is like Standard Generalized Markup Language (SGML) in that it is a metalanguage, or a language for describing languages. XML enables authors to define their own tags. XML is a formal specification of the World Wide Web Consortium.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface. On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. A plug-in application is recognized automatically by the browser and its function is integrated into the main HTML file that is being presented.

Crawling is the method of following links on the web to different websites, and gathering the contents of these websites for storage in the search engines databases. A crawler or spider is a type of bot and may comprise an application or component that can gather information about sites by crawling a network (e.g., the Internet and World Wide Web). Basically, a crawler's role can include copying and indexing the pages that it finds. The crawler downloads web content (web pages, images, documents and other files), and then follow links (e.g., hyperlinks) within these web contents to download the linked contents. The linked contents can be on the same site or on a different website. The crawler can store network addresses (e.g., URLs) and index keywords and text of each page it encounters. Such indexes may be referred to as search indexes.

Crawling may continue until a crawler finds a logical stop, such as a dead end with no external links or reaching the set number of levels inside the website's link structure. If a website is not linked from other websites on the internet, the crawler will be unable to locate it. Therefore, if the website is new, and has no links from other sites, that website has to be submitted to each of the search engines for crawling. Usually search engines crawl only a few (three or four) levels deep from the homepage of a website. Some crawlers perform what is known as “deep crawling” as compared to a “surface crawl”. In deep crawling, the crawler collects information many layers deep and index every page it finds. Google is an exemplary deep crawling search engine.

Crawlers typically follow specified guidelines using the robots exclusion protocol (e.g., robots.txt). The robots.txt can specify the files or folders that crawler should and/or should not index in its database.

Similar to an index of a book, a search engine also extracts and builds a catalog of all the words that appear on each web page and the number of times it appears on that page etc. Indexing of web content is a challenging task assuming an average of 1000 words per web page and billions of such pages. Indexes are used for searching by keywords, therefore, it has to be stored in the memory of computers to provide quick access to the search results.

Indexing the search results of a crawler may begin with the parsing the site's content using a parser. The parser can extract the relevant information from a page by excluding certain common words (such as a, an, the—also known as stop words), HTML tags, JavaScripting and other characters. A parser may also eliminate commonly occurring content in the pages (such as navigation links) so that they are not counted as a part of the page's content. Once the indexing is completed, the results can be stored in database to help the retrieval of the information.

Login may be defined as a process of identifying and authenticating to control access to computer systems or networks. Logging in or Login may also be understood as a process for entering in information related to an user name or identifier (also referred to as an account name) and a password in order to access restricted information, a computer, network or site. As a verb, to login may be considered the action of access. As a noun, a login may be understood the actual profile used to access a network and usually comprises a name and password.

A tag may be defined as a generic term for a language element descriptor. Tags may be used by a browser in determining how data element are to be presented. A tag may comprise a markup that delimits an element. For example, tags may be used to mark the semantic or logical structure of a unit of data (element) in HTML, XML or other markup language. A tag can include a name which refers to an element declaration and may include attributes. In HTML, a tag may be used for marking-up text in various ways so that it is formatted in a Web document. A tag is an element in action. It starts with “<” and ends with “>”. A tag can have attributes, but this is not necessary. The end of the element is signaled with the tag without its attributes, and with “/” as the first character. For example, the ending tag for <B> is </B>. A sample is the tag <title> to mark the beginning of a title.

A password tag may be defined as a particular type of input tag (e.g., an HTML input tag) for receiving a password. In HTML, a password tag is a form tag that creates an input field into which text may be input. When text is input into the input field created by the password tag, the input text can be hidden with obscuring characters such as asterisks or dots. An exemplary HTML password tag may include the following attributes: <INPUT TYPE=“password” NAME=“nameFirst” VALUE=“Your Name”>.

A link, or hyperlink, basically is a connection from one resource to another. In HTML, a link may have two ends called anchors and a direction. The link starts at a source anchor and points to the destination anchor, which may be any resource (e.g., an image, a video clip, a sound bite, a program, an HTML document, an element within an HTML document, etc.). A default behavior associated with a link is the retrieval of another resource. This behavior is commonly and implicitly obtained by selecting the link (e.g., by clicking, through keyboard input, etc.). The syntax of creating an anchor may be as follows: <a href=“url”>Text to be displayed</a>. The <a> tag is used to create an anchor to link from, the href attribute is used to address the document to link to, and the words between the open and close of the anchor tag will be displayed as a hyperlink.

The following HTML excerpt contains two links, one whose destination anchor is an HTML document named “chapter2.html” and the other whose destination anchor is a GIF image in the file “forest.gif”:

<BODY>

<P>You'll find a lot more in <A href=“chapter2.html”>chapter two</A>.

See also this <A href=“../images/forest.gif”>map of the enchanted forest.</A>

</BODY>

By activating these links (by clicking with the mouse, through keyboard input, voice commands, etc.), users may visit these resources. The “href” attribute in each source anchor specifies the address of the destination anchor with a URI. The destination anchor of a link may be an element within an HTML document. The destination anchor may be given an anchor name and any URI addressing this anchor must include the name as its fragment identifier. Destination anchors in HTML documents may be specified either by the A element (naming it with the name attribute), or by any other element (naming with the id attribute).

Based on the foregoing specification, embodiments of the invention may be implemented using computer programming or engineering techniques including computer software, firmware, hardware or any combination or subset thereof. Any such resulting program—having computer-readable code—may be embodied or provided in one or more computer-readable media, thereby making a computer program product (i.e., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link.

An article of manufacture containing the computer code may be made and/or used by executing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

While various embodiments have been described, they have been presented by way of example only, and not limitation. Thus, the breadth and scope of any embodiment should not be limited by any of the above described exemplary embodiments, but should be defined only in accordance with the following claims and their equivalents.

1. A method, comprising:
obtaining information for logging in under an identity claimed by a subject;
submitting the obtained information in an attempt to login under the claimed identity; and
analyzing a response to the login attempt to determine whether the identity with the site claimed by the subject is valid.

2. The method of claim 1, wherein the information comprises a password.

3. The method of claim 2, wherein the login information further comprises an identifier associated with the claimed identity.

4. The method of claim 1, wherein the information is obtained during registration with a service.

5. The method of claim 3, wherein the information is obtained in response to a request during the registration.

6. The method of claim 1, wherein the information identifies a computer system to which the login information is submitted.

7. The method of claim 6, further comprising determining whether the computer system is pre-registered, and if the computer system is determined not to be pre-registered, registering the computer system to the submitting.

8. The method of claim 7, wherein the registering comprises:
accessing the computer system;
analyzing pages of the computer system to locate a login page of the computer system adapted for receiving the obtained login information; and
storing location information for locating login page.

9. The method of claim 8, wherein the analyzing of the pages of the computer system further comprises iteratively searching the pages of the computer system for computer code that defines an input field adapted for receiving login related information.

10. The method of claim 9, wherein the iterative search comprises, for each page:
searching the page for the computer code defining the input field; and
if the computer code defining the input field is not found in the page, searching the page for links to other pages.

11. The method of claim 10, wherein the searching the page for links to other pages further comprises conducting a keyword search of the page for links to other pages that contain login-related keywords.

12. The method of claim 11, wherein the login-related keywords comprise password-related keywords.

13. The method of claim 9, wherein the input field comprises a password input field adapted for receiving a password.

14. The method of claim 9, wherein the input field is defined by a tag.

15. The method of claim 7, wherein the registering comprises:
accessing a login page of the computer system;
submitting random characters in an input field presented in the login page, the submitting of the random characters resulting the presentment of a failure to login page;
analyzing the presented failure to login page for failure-related keywords; and
storing failure-related keywords found in the failure to login page.

16. The method of claim 1, wherein the submitting further comprises:
obtaining location information for locating to a login page adapted for receiving the obtained information;
accessing the login page using the location information; and
inputting the information into the login page to submit the information.

17. The method of claim 1, wherein the analyzing the response further comprises comparing the response to a known failure to login response.

18. The method of claim 17, wherein the analyzing the response further comprises searching the response for keywords indicating that a successful login attempt.

19. A system, comprising:
logic for obtaining information for logging in under an identity claimed by a subject;
logic for submitting the obtained information in an attempt to login under the claimed identity; and
logic for analyzing a response to the login attempt to determine whether the identity with the site claimed by the subject is valid.

20. A computer program product, comprising:
computer code for obtaining information for logging in under an identity claimed by a subject;
computer code for submitting the obtained information in an attempt to login under the claimed identity; and
computer code for analyzing a response to the login attempt to determine whether the identity with the site claimed by the subject is valid.
